(19) United States
(12) Patent Application Publication
(10) Pub. No.: US 2002/0089413 A1
(43) Pub. Date: Jul. 11, 2002

(54) Authentication of a person by hand recognition

(76) Inventors: Hans Jorg Heger, Munchen (DE); Wolfgang Kupper, Munchen (DE)

Correspondence Address: STAAS & HALSEY LLP, 700 11TH STREET, NW, SUITE 500, WASHINGTON, DC, 20001, US

(21) Appl. No.: 10/040,413

(22) Filed: Jan. 9, 2002

(30) Foreign Application Priority Data
Jan. 9, 2001 (DE) 101 00 616.0

(51) Int. Cl. H04Q 1/00

(52) U.S. Cl. 340/5.82

(57) ABSTRACT

A person is authenticated by hand recognition carried out based on scanning data obtained for a first position and for a transition into a second position. Scanning data obtained in the second position may be used also.

### CROSS REFERENCE TO RELATED APPLICATIONS

This application is based on and hereby claims priority to German Patent Application No. 10100616.0 filed on Jan. 9, 2001, the contents of which are hereby incorporated by reference.

### BACKGROUND OF THE INVENTION

1. Field of the Invention

The invention relates to a method and system for the authentication of a person by hand recognition.

2. Description of the Related Art

In order to authenticate persons, biometric methods can be applied, which means that the user is recognized by using bodily features or characteristic behavior. One established biometric method is authentication by recognizing the shape of the hand or part of the hand. Recognizing the hand contour has previously been carried out by the hand being placed on a plate. In the process, the positioning of the hand is predefined by physical aids, such as small steel pins or the like. Then, an image of the hand is recorded by scanning and processed further. On the basis of this image, with the defined hand position, the authentication of the person is carried out. The hand detection systems described in the prior art are restricted by the guidance of the hand into a defined recognition position.

U.S. Pat. No. 4,720,869 also discloses a system for hand recognition in which the hand is scanned simultaneously from two different directions.

Finally, U.S. Pat. Nos. 5,533, 177, 5,751,843, 5,828 779, EP 0 560 779 B1, EP 0 713 592 B1, EP 0 800 145 A2 and WO 98/38533 disclose systems in which movements of hand and arm can be scanned.

Like every authentication method, biometric systems are also subject to attempts at confusion. One obvious confusion consists in confusing the biometric system by model simulation. In the case of hand recognition, three-dimensional imitation hands are conceivable.

### SUMMARY OF THE INVENTION

On this basis, the invention is based on the object of increasing the recognition security in hand recognition, without the recognition operation being felt to be unpleasant by the person to be authenticated.

The fact that not only a stationary image of the hand is recorded, but also the transition of the hand into a second position is scanned, means that the recognition of a living being can be implemented. In this case, the scanning can be performed by a sensor, for example by a video camera or by a still camera which is able to produce a sufficiently fast sequence of images.

Particularly secure recognition of a living person results if the person is only authenticated when it is recognized that the hand moves intrinsically during the transition from the first position to the second position. Such a movement can intrinsically be a movement of the fingers or of the palm of the hand, in particular a curving movement. In this way, it is possible to avoid impermissible authentication being achieved by a three-dimensional imitation hand being simply moved to and fro.

Furthermore, during the hand recognition, the time needed for the transition can be taken into account. On the basis of different starting and final positions, different transition times are permitted for this purpose, so that authentication only takes place in the case of a transition which is completed at a natural speed of movement.

If the manner in which the person to be authenticated performs the transition between the first and the second position is left free to the person to be authenticated, then by registering the selected transition in the learning phase of the hand recognition system, an additional aspect can be taken into account, and the recognition security can be increased still further by gesture recognition. The person will then only be authenticated when it has been recognized that this specific transition has been performed. The person is, so to speak, authenticated on the basis of a personal, individual gesture.

Finally, the hand can also be further scanned in the second position and the hand recognition can be carried out on the basis of the scanning data obtained for the second position. It is preferable if, in the second position, the hand has to assume a different hand shape than in the first position. For example, instead of a flat hand, a fist may be predefined. By this procedure, further characteristic features can be scanned and taken into account in the hand recognition, so that the recognition security is increased further.

A system may implement the method, for example, by appropriate programming and setting up of a data processing system, to which the scanning data can be supplied.

A program product for a data processing system which contains software code sections with which one of the methods outlined can be executed on a data processing system may be executed by suitable implementation of the method in a programming language. For this purpose, the software code sections are stored. In this case, a program product is understood to mean the program as a commercial product. It may be present in any desired form, for example on paper, a computer-readable data medium or distributed via a network.

### BRIEF DESCRIPTION OF THE DRAWINGS

Further significant and advantageous features of the invention emerge from the description of an exemplary embodiment, using the drawing, in which:

FIGS. 1A and 1B are two images of a hand in two different positions.

FIG. 1C is a schematic representation of a plurality of images of a hand.

FIG. 2 is a block diagram of a system according to the present invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

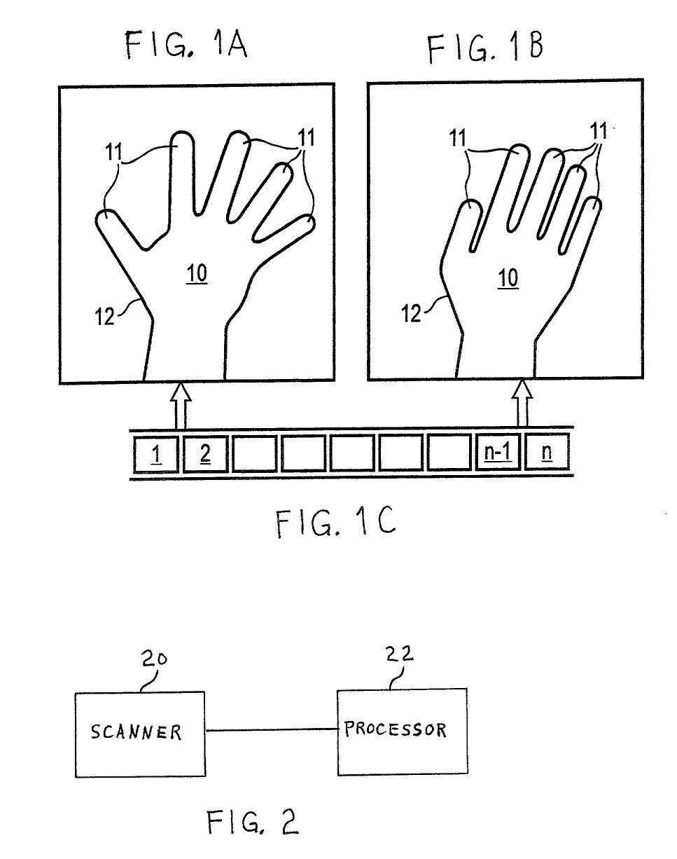

As illustrated in FIG. 2, a generic system of the present invention includes a scanner 20 and a processor 22. In a preferred system for the implementation of the invention, the hand 10 of a person is scanned by a video camera to record an image. The person is requested to assume first and second positions, one after another with his or her hand 10. The video camera produces images 1 to n of the hand 10, the image 1 being recorded in the first position and the image n in the second position. The image 1 of the first position and the image n of the second position are illustrated enlarged in FIGS. 1A and 1C. By using the images 2 to n-1 illustrated schematically in FIG. 1C, the transition of the hand 10 from the first position to the second position is scanned.

In position 1, the hand 10 is held as a flat hand 10 with spread fingers 11. On the basis of the scanning data obtained in this position, hand recognition is carried out, characteristic features being extracted from the contour 12 of the hand 10 via a segmentation operation. These features are compared with features recorded in a learning phase for the hands of different persons to be authenticated and, if there is sufficient agreement, a person is provisionally authenticated.

Instead of being used for identification, as described, the method can also be used for the verification of the person. In this case, the claimed identity of the person is known and is verified or not verified by hand recognition.

In a further step, it is established whether the hand 10 has moved, preferably intrinsically, during the transition from the first to the second position. In the example shown, the movement is carried out by closing the fingers 11 of the hand 10, which were spread in the first position. Closing of this type would not be possible in the case of a simple rigid imitation hand. Accordingly, the hand recognition recognizes that this is the hand 10 of a living person.

Preferably, the contour 12 of the hand 10 scanned in the second position is also subjected to a hand recognition method.

If the hand recognition overall has proceeded positively, then the person is authenticated and steps can be initiated which depend on the place and intended use of the hand recognition.

Inherent in all the embodiments of the invention is the advantage that detection of the living hand is performed, and therefore the recognition security can be increased.

The invention has been described in detail with particular reference to preferred embodiments thereof and examples, but it will be understood that variations and modifications can be effected within the spirit and scope of the invention.

What is claimed is:

1. A method for authentication of a person by hand recognition, comprising:
scanning a hand in a first position and during transition to a second position; and
carrying out hand recognition based on said scanning.

2. The method as claimed in claim 1, further comprising detecting a living person based on scanning data obtained during said scanning of the transition.

3. The method as claimed in claim 2, further comprising authenticating the living person only if it is recognized that the hand moves intrinsically during the transition.

4. The method as claimed in claim 1, wherein said carrying out of the hand recognition is based on scanning data obtained by said scanning of the first position and the transition.

5. The method as claimed in claim 1, wherein said carrying out of the hand recognition takes into account an amount of time needed for the transition.

6. The method as claimed in claim 1, further comprising authenticating the living person only if a specific transition is recognized.

7. The method as claimed in claim 1,
further comprising scanning the hand in the second position, and
wherein said carrying out the hand recognition is further based on scanning data obtained for the second position.

8. The method as claimed in claim 7, wherein the hand has to assume a different hand shape in the second position than in the first position.

9. A system for authentication of a person by hand recognition, comprising:
a scanner to scan a hand in a first position and during transition to a second position, to obtain scanning data; and
a processor, coupled to said scanner, to perform hand recognition based on the scanning data.

10. A computer readable medium storing at least one computer software module for controlling a data processing system to perform a method for authentication of a person by hand recognition, said method comprising:
scanning a hand in a first position and during transition to a second position; and
carrying out hand recognition based on said scanning.
